(19) United States
(12) Patent Application Publication
(10) Pub. No.: US 2025/0206199 A1
(43) Pub. Date: Jun. 26, 2025

(54) VEHICULAR DRIVER MONITORING SYSTEM WITH AUTOMATIC SEAT SETTINGS

(71) Applicant: Magna Electronics Inc., Auburn Hills, MI (US)

(72) Inventors: Aniketh U. Achar, Bangalore (IN); Aditya Kumar Chari, Bangalore (IN); Delwin Mathew Joseph, Kerala (IN)

(21) Appl. No.: 18/983,552

(22) Filed: Dec. 17, 2024

Related U.S. Application Data
(60) Provisional application No. 63/551,158, filed on Feb. 8, 2024.
(60) Provisional application No. 63/613,253, filed on Dec. 21, 2023.

(51) Int. Cl. B60N 2/02; B60N 2/00

(52) U.S. Cl. CPC B60N 2/0273; B60N 2/0025; B60N 2/0277; B60N 2/0278; B60N 2210/24; B60N 2220/10

(57) ABSTRACT

A vehicular driver monitoring system includes a camera disposed at an interior cabin of a vehicle equipped with the system and viewing at least a portion of a driver of the vehicle. The system includes an electronic control unit (ECU) including electronic circuitry and associated software. Frames of image data captured by the camera are transferred to and are processed at the ECU. The system, responsive to processing at the ECU of frames of image data captured by the camera and transferred to the ECU, determines location of the head of the driver. The system determines a configuration for a driver's seat of the vehicle based at least in part on the determined location of the head of the driver. The system adjusts the driver's seat of the vehicle using the determined configuration for the driver's seat.

### CROSS REFERENCE TO RELATED APPLICATIONS

The present application claims the filing benefits of U.S. provisional application Ser. No. 63/551,158, filed Feb. 8, 2024, and U.S. provisional application Ser. No. 63/613,253, filed Dec. 21, 2023, which are hereby incorporated herein by reference in their entireties.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driver monitoring system includes a camera disposed at an interior cabin of a vehicle equipped with the vehicular driver monitoring system and viewing at least a portion of a driver of the vehicle. The camera is operable to capture image data. The camera includes a CMOS imaging array having at least one million photosensors arranged in rows and columns. An electronic control unit (ECU) includes electronic circuitry and associated software. Image data captured by the camera is transferred to and is processed at the ECU. The vehicular driving monitoring system, via processing at the ECU of image data captured by the camera and transferred to the ECU, determines location of the head of the driver within the interior cabin of the vehicle. The vehicular driver monitoring system determines a configuration for a driver's seat of the vehicle based at least in part on the determined location of the head of the drive. The vehicular driver monitoring system adjusts the driver's seat of the vehicle using the determined configuration for the driver's seat.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a driver monitoring system that incorporates one or more cameras;

FIG. 2 is a perspective view of an interior rearview mirror assembly, showing an interior-viewing camera;

FIG. 3 is a perspective view of a smart seat of the system of FIG. 1;

FIG. 4 is a block diagram of the system of FIG. 1;

FIG. 5 is a frame of image data captured by a driver monitoring camera for facial recognition;

FIG. 6 is a frame of image data captured by a driver monitoring camera for posture detection;

FIG. 7 is a plot of height versus angle for a driver sitting in a driver's seat;

FIG. 8 is a plot of height versus distance for a driver sitting in a driver's seat;

FIG. 9 is a schematic view of angles and distances for averages drivers; and

FIG. 10 is a plan view of exemplary functions of the driver monitoring system.

### DESCRIPTION OF THE PREFERRED EMBODIMENTS

Adjusting a driver's seat in a car is a fundamental step in ensuring a comfortable and safe driving experience. Typically, the driver seat has a range of customization options, allowing individuals to tailor their position to their specific preferences and ergonomic needs. For example, a driver seat may include power seat adjustments (i.e., using electric motors), a seat memory system (with one or more profiles), driver recognition (e.g., based on the key used to start the vehicle), and/or active seat adjustments (e.g., passive adaptive cushions). Proper seat adjustment not only enhances comfort during long journeys but also plays a crucial role in promoting safety by ensuring that the driver maintains a clear line of sight, easy access to controls, and optimal reaction times. It is a simple yet essential task that every driver should undertake before operating the vehicle, as it contributes to a more pleasant and secure driving experience.

A vehicle vision system and/or driving assist system or driver comfort system (DCS) and/or driver monitoring system (DMS) operates to capture images interior of the vehicle and may process the captured image data to monitor occupants of the vehicle and/or display images and to detect objects within the vehicle. The vision system includes an image processor or image processing system that is operable to receive image data from one or more cameras and may provide an output to a display device for displaying images representative of the captured image data.

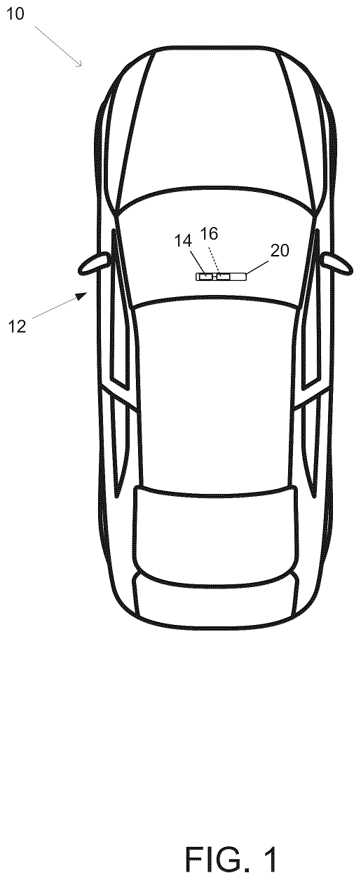

Referring now to the drawings and the illustrative embodiments depicted therein, a vehicle 10 includes a driving assist system or DMS 12 that includes at least one interior viewing imaging sensor or camera 14, with the camera 14 having a lens for focusing images at or onto an imaging array or imaging plane or imager of the camera 14 (FIG. 1). The system 12 includes a control or electronic control unit (ECU) 16 that comprises electronic circuitry and associated software, with the electronic circuitry including a data processor or image processor that is operable to process image data captured by the camera or cameras 14 (and may process image data captured by other cameras at the vehicle 10, such as exterior viewing cameras disposed at locations so as to have respective fields of view exterior of the vehicle 10) and/or may provide an output to a display device for displaying video images for viewing by the driver of the vehicle. Although shown in the illustrated embodiment as disposed at an interior rearview mirror assembly 18 of the vehicle 10, the driver monitoring camera 14 and ECU 16 (and optionally one or more near infrared light emitters) may be disposed at any suitable position within the vehicle 10, such as at a dashboard or gauge cluster or windshield mounted electronics module or the like. The data transfer or signal communication from the camera 14 to the ECU 16 may comprise any suitable data or communication link, such as a vehicle network bus or the like of the equipped vehicle 10.

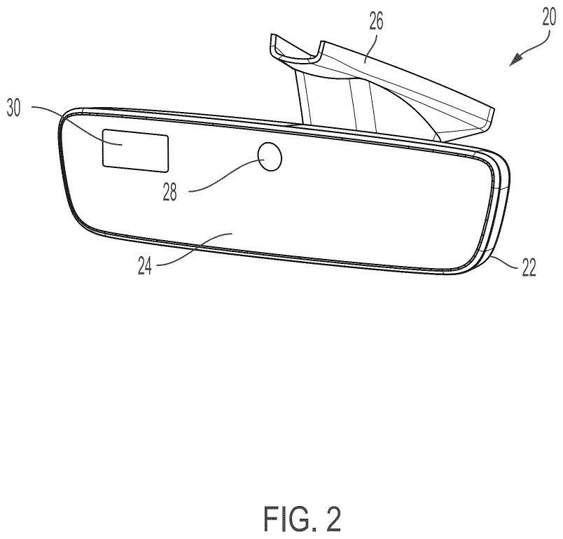

FIG. 2 illustrates an exemplary interior rearview mirror assembly 20 of the equipped vehicle 10. The interior rearview mirror assembly 20 includes a casing 22 and a reflective element 24 positioned at a front portion of the casing 22 (FIG. 1). In the illustrated embodiment, the mirror assembly 20 is configured to be adjustably mounted to an interior portion of a vehicle (such as to an interior or in-cabin surface of a vehicle windshield or a headliner of a vehicle or the like) via a mounting structure or mounting configuration or assembly or stay 26. The system includes an interior-viewing camera 28 disposed at and movable with the mirror head. For example, the camera 28 may be disposed behind the mirror reflective element 24 and view through the mirror reflective element 24 for capturing image data representative of the interior cabin of the vehicle, including the driver's head region and occupant region of the vehicle cabin. The system may utilize aspects of driver monitoring systems or occupant monitoring systems described in U.S. Pat. Nos. 11,930,264; 11,827,153; 11,780,372 and/or 11,639,134 and/or International Publication No. WO 2023/220222, which are all hereby incorporated herein by reference in their entireties. The mirror assembly 20 may include one or more infrared (IR) or near-infrared (NIR) light emitter(s) 30 that, when electrically powered to emit light, emit near-infrared light that passes through the reflective element 24 to illuminate the head region of the driver and/or passengers of the vehicle.

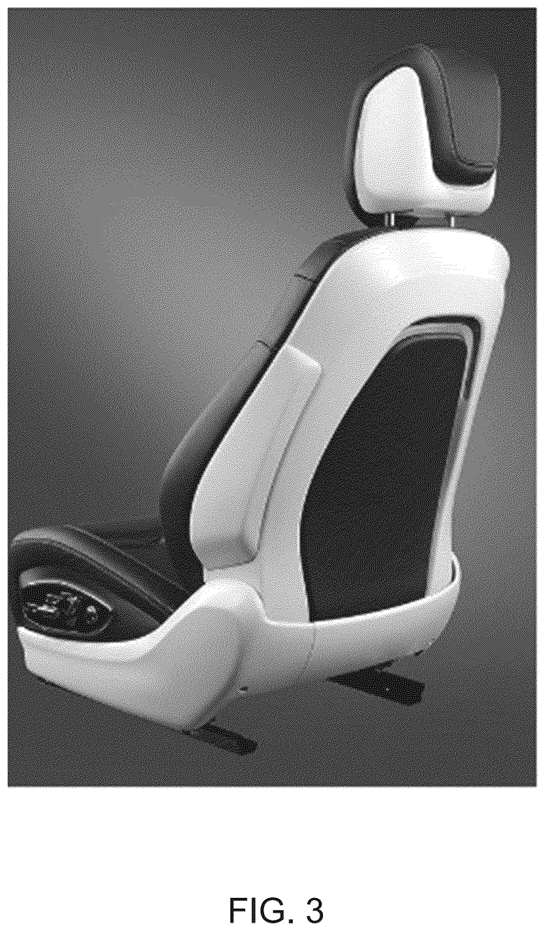

Implementations herein include a DMS or occupant monitoring system (OMS) or vehicular vision system that improves the efficiency and user-friendliness of an electric or power car seat adjustment process and/or an interior/exterior mirror adjustment process (adjustment of the mirror reflective elements of the exterior rearview mirrors and/or the interior rearview mirror to set the appropriate rearward view and minimize blind spots of the driver based on the seat setting of the driver and the driver information) while also enhancing the driver's comfort and safety during operation of the vehicle. For example, the system includes a “smart seat” (FIG. 3) that utilizes facial recognition technology (e.g., facial recognition derived from image data captured by an interior camera) and a height-based recommendation system to suggest a car seat position and/or automatically adjust the power car seat's movable parameters for new users, occupants, and/or drivers. The seat includes one or more electric motor-based mechanisms to adjust the seat. For example, the power seat may adjust a position of the seat (e.g., forward and back, upward and downward, etc.), a tilt of the seat, a recline of the seat back (i.e., backrest), a tilt of the headrest (i.e., head restraint), a height of the headrest, a lumbar support of the seat, a side bolster of the seat, an adaptive cushion of the seat, a position of the steering wheel (e.g., telescopic adjustment, upward or downward adjustment, angle of the steering wheel, etc.), etc. Known techniques rely on manual switch-operated profiles for seat adjustments. For example, a vehicle may include two switches that each recalls a specific seat configuration. The user may select the first switch to recall a first specific seat configuration or select the second switch to recall a second specific seat arrangement.

Optionally, the system may adjust one or more mirrors of the vehicle or one or more displays (e.g., a head-up display) based on the height or size of the driver (e.g., a location of the driver's head within the cabin of the vehicle). For example, the system may adjust a mirror head and mirror reflective element of an interior rearview mirror assembly and/or a mirror reflective element of one or more side exterior rearview mirror assemblies of the vehicle using one or more actuators of the mirror(s) based on the determined height or head position of the driver. As another example, the system may adjust a position of a head-up display based on the determined height or head position of the driver.

Optionally, the system may be integrated as an add-on to an existing DMS by, for example, utilizing images generated by the DMS unit. The system includes a driver recognition module that, using image data captured by, for example, a driver monitoring camera, detects and identifies or recognizes a driver of the vehicle. Optionally, the system includes incorporation of facial recognition algorithms within the DMS system. Using facial recognition, the system may determine whether the driver is a new driver (i.e., the system has not previously identified the driver) or a returning driver (i.e., the system has previously identified the driver). Returning drivers may have associated profiles that store information (e.g., settings or parameters) associated with each respective identified returning driver. For example, the profile stores optimal suggested or desired seat and/or mirror positions for the associated driver. The system may create a new profile for an identified new driver.

The profiles may include preferred seat and/or mirror positions. For example, the profiles are stored at a database and include optimal seating arrangements for individual drivers. Optionally, the system performs automatic seat adjustment. For example, the system uses driver recognition technology to automatically select a profile associated with the driver and adjust the driver's seat based on settings stored within the profile. The system may store any number of profiles for any number of drivers at the database. The database may be stored local to the vehicle (e.g., at on-board memory) or remote from the vehicle (e.g., at a cloud database accessed via the Internet or other wireless communication). Each profile may include information (e.g., biometric information) to allow the system to recognize the associated driver (e.g., via facial recognition).

The system may provide a manual seat, steering wheel, or mirror override function. That is, the system may allow for manual adjustment of the seat, steering wheel, or mirrors by the driver or user (e.g., via one or more knobs, buttons, levers, etc.). After the user completes the manual override, the system may update the user's profile with the updated seat, steering wheel, and/or mirror configuration and restore the updated seat, steering wheel, display configuration, and/or mirror configuration the next time the user is recognized.

Optionally, the system may recommend (e.g., via a notification on a display or via automatic adjustment of the seat) an optimal seating position, steering wheel position, display position, and/or mirror position for the user. The optimal positions may be tailored to the user based on a determined or estimated height (e.g., head position) and/or a determined or estimated weight of the user. For example, the system may estimate a height of the user (e.g., via processing of image data captured by the interior camera) and/or a weight of the user (e.g., via a seat sensor and/or image data captured by the interior camera). The system may determine or estimate a height of the user based on a position of one or more features or landmarks in frames of image data. For example, the system may compare a position of a known landmark of the vehicle (e.g., an edge of the headliner, an edge of one or more portions of the seat or seat belt, an edge of a window, etc.) to a position of one or more features of the user (e.g., the top of the head, the tops of the shoulders, a facial feature, such as the eyes or mouth of the user, etc.) to determine a height (or torso length) of the user.

Based on the estimated height and/or weight, the system may determine an optimal seat position for the user. Optionally, a machine learning model (e.g., a deep learning model) is trained (e.g., on training samples including heights, weights, and optimal positions for various drivers) to predict the optimal seat, steering wheel, and/or mirror recommendations. The machine learning model may be stored at the database. The system may generate the recommendation automatically for new users (e.g., the first time the system determines or identifies a user). The system may re-generate the recommendation for identified or returning users based on user input (e.g., the user requests a new recommendation via one or more user inputs).

Thus, the system may utilize facial recognition algorithms to determine the driver (or other occupant or user of the vehicle). The system, if the driver is a new user (e.g., does not have an associated profile) or a returning user (e.g., does have an associated profile) who provides a request, determines the driver's height and weight via the DMS (i.e., using the DMS camera) and/or the seat's pressure sensor. Once the driver is determined, the corresponding driver profile may be created (for a new driver) or retrieved from the database (for a returning driver). The profile may contain the optimal seating arrangement and/or mirror positioning for that specific driver based, at least in part, on the driver's determined height and/or weight. The system may then automatically adjust the seat to this arrangement. In the case of a new user, the user's determined height and weight may be used to predict an optimal seating arrangement based on their body size, and the system may adjust the seat accordingly.

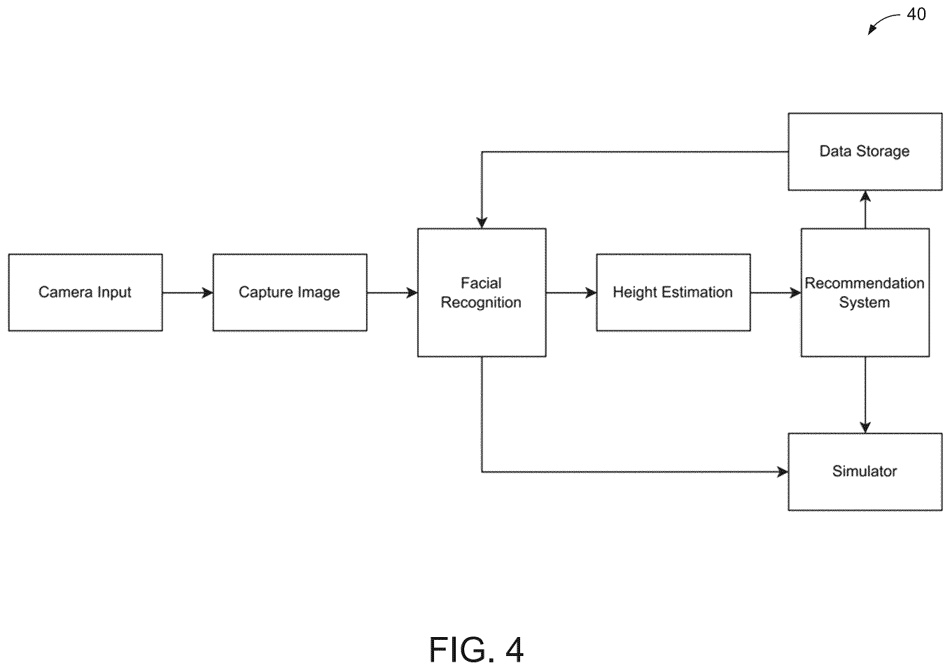

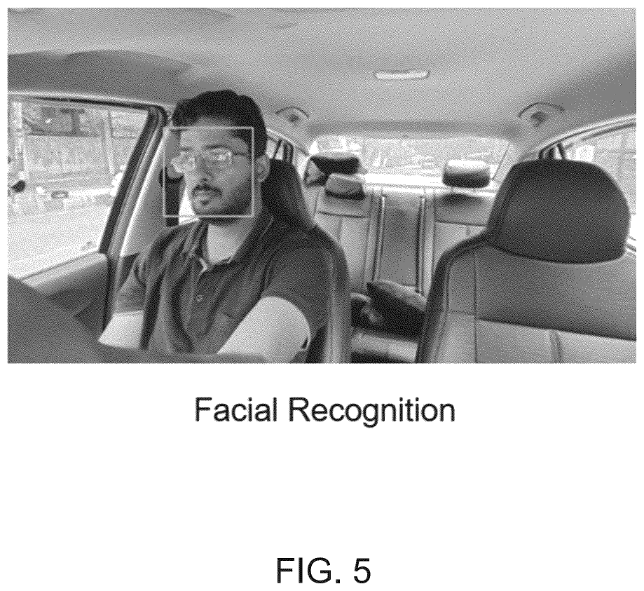

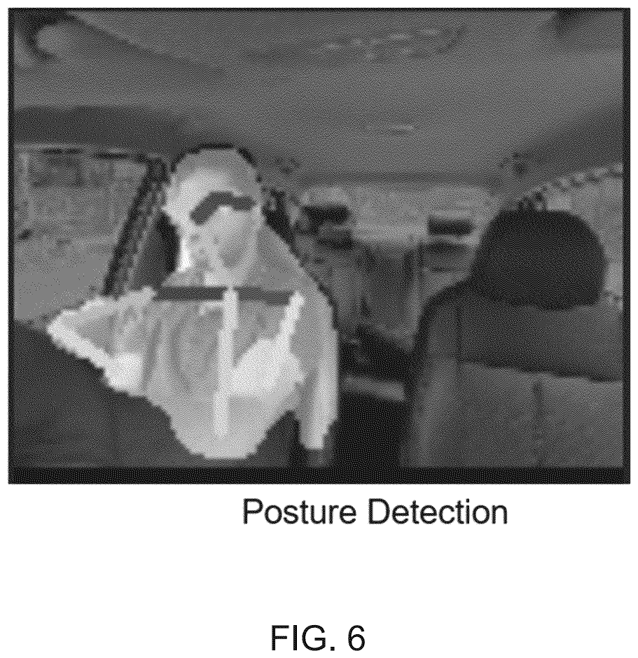

Referring now to FIG. 4, an exemplary block diagram 40 of the system is illustrated. Here, the system receives an image (i.e., a frame of image data captured by an interior DMS camera) and applies a facial recognition algorithm (FIG. 5) to identify and/or recognize the driver. When the driver is recognized (i.e., has an existing profile), the profile is retrieved. When the driver is not recognized (i.e., is identified as a new driver and does not have an associated profile and/or estimated height), then the system estimates the driver's height using posture detection algorithm (FIG. 6).

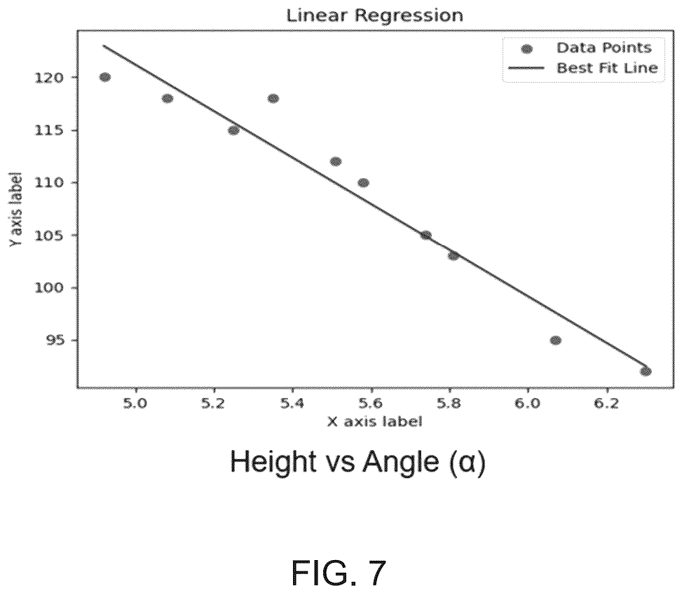

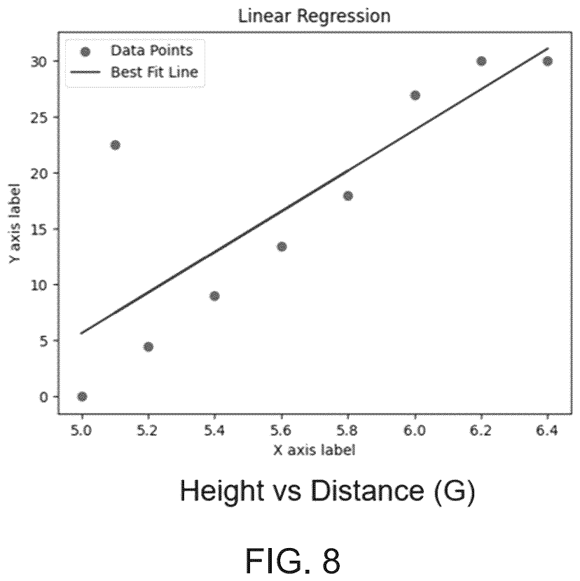

Once the user is recognized and the associated driver profile is retrieved (e.g., from a database that stores previous driver's profiles) and/or generated (for a new driver), the optimal driver seat arrangement for that specific driver (based on the driver's size, height, posture, etc.) is determined. The system recommends the optimal arrangement to the driver (e.g., via a display of the vehicle) and/or adjusts the seats according to the optimal arrangement. When a new driver enters the vehicle and the system determines that the optimal driver seat arrangement is not yet available, the system estimates or determines height, weight, etc. of the driver. Optionally, the system estimates a height or other parameters of the driver (or other occupant) using one or more linear regressions, such as linear regressions based on one or more angles or more or one distances measured by the camera (FIGS. 7 and 8). For example, the system determines or estimates a height of the user by determining an angle of the driver's torso (FIG. 8) and/or a distance between the steering wheel and the driver.

The system may use driver data collected from a plurality of drivers and stored in the database to determine the one or more linear regressions. The driver data may include a respective driver's height, an angle of the driver's torso (α) when sitting in a vehicle (e.g., relative to the camera, the ground, the seat, the driver's legs, etc.), and/or the distance between the respective driver and the steering wheel of the vehicle (G) when sitting in the vehicle (or other appropriate distances). In one example, the system may determine, based on driver data of driver heights in relationship to the angle of the driver's torso (α), a linear regression of the relationship between driver height with respect to torso angle (α). The system may use the linear regression data to determine a height of an identified driver based on a determined angle of the identified driver's torso (α) when sitting in the vehicle (e.g., based on processing of captured image data). Alternatively, the system may determine, based on driver data of driver torso lengths in relationship to the angle of the driver's torso (α), a linear regression of the relationship between driver torso length with respect to torso angle (α). The system may use the linear regression data to determine a torso length of an identified driver based on a determined angle of the identified driver's torso (α) when sitting in the vehicle. In another example, the system may determine, based on driver data of driver heights in relationship to distance (G), a linear regression of the relationship between driver height with respect to distance (G). The system may use the linear regression to determine the height of the identified driver based on a determined distance between the identified driver and the steering wheel (G). For example, the distance between the respective driver and the steering wheel (G) may provide an estimate of the arm length of the driver, which may then be used to estimate the height of the driver.

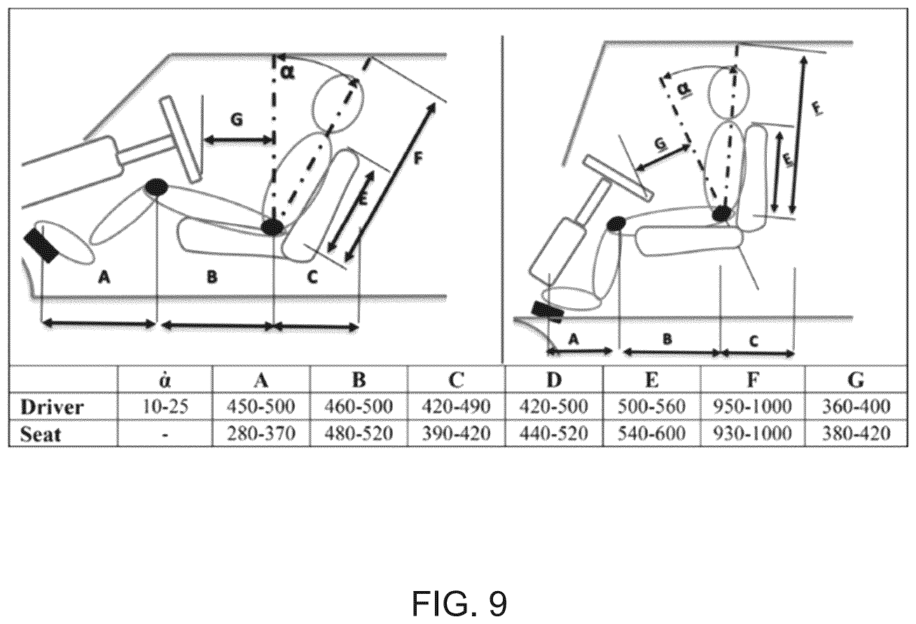

The system may use the driver data and/or statistical ratios of human body proportions to determine, based at least in part on either the determined height of the identified driver or the determined torso length of the identified driver, bodily proportions (i.e., parameters) of the identified driver (FIG. 9). The statistical ratios may include, sitting height ratio, leg-to-body ratio, etc. In one example, based on determining the height of the identified driver and driver data and/or a statistical leg-to-body ratio, the system may determine the leg length of the identified driver (A, B). Based on the determined bodily proportions of the identified driver, the system may adjust the seat, the steering wheel, the pedals, displays, and/or the mirrors of the vehicle. In one example, based on the determined leg length of the identified driver (A, B), the system may adjust the seat laterally fore or aft and/or adjust a pedal position of the vehicle. In another example, based on determining the height of the identified driver and driver data and/or a statistical sitting height ratio, the system may adjust an angle of the seatback of the seat and/or a height of the seat. In yet another example, based on determining the height of the identified driver and driver data and/or a statistical arm-span to height ratio, the system may adjust the angle of the seatback of the seat, adjust the seat fore or aft, and/or adjust a position of the steering wheel.

Using the determined parameters of the driver, the system determines or predicts an optimal seating arrangement (i.e., determines or predicts a seat position and orientation, headrest height, mirror position, steering wheel position, pedal position, display position, etc.) for the body size of the driver. The system then creates or updates a corresponding profile with this information and adjusts the seat, mirrors, pedals, displays, and/or steering wheel accordingly. The system may apply these settings based on the stored profile each time the driver is detected or determined within the vehicle. When the user feels a need to adjust the suggested arrangement (e.g., by adjusting a position of the seat, mirrors, pedals, steering wheel, etc.), the user may manually readjust, and the system may update the user's profile with the adjusted or updated arrangement. Additionally or alternatively, the system may store the adjustments and/or determined parameters (e.g., height, weight, etc.) of the user to further train or fine-tune the machine learning model (e.g., the deep learning mode).

For example, after the system finishes automatically moving the seat to the determined optimal position or configuration based on the height and/or weight of the user, the user may provide one or more adjustments or tweaks to the position or configuration. Similarly, the user may adjust the positioning of one or more mirrors of the vehicle or adjust the positioning of the steering wheel of the vehicle. The system may store the new or updated configuration to the user's profile for future use. For example, the next time the user returns to the vehicle, the system may automatically configure the seat or mirrors based on the adjustments the user manually made to the generated configuration. Optionally, the user's manual adjustments may be used to further train or fine-tune the machine learning model that generates the seating configurations and/or mirror configurations based on the user's height and/or weight.

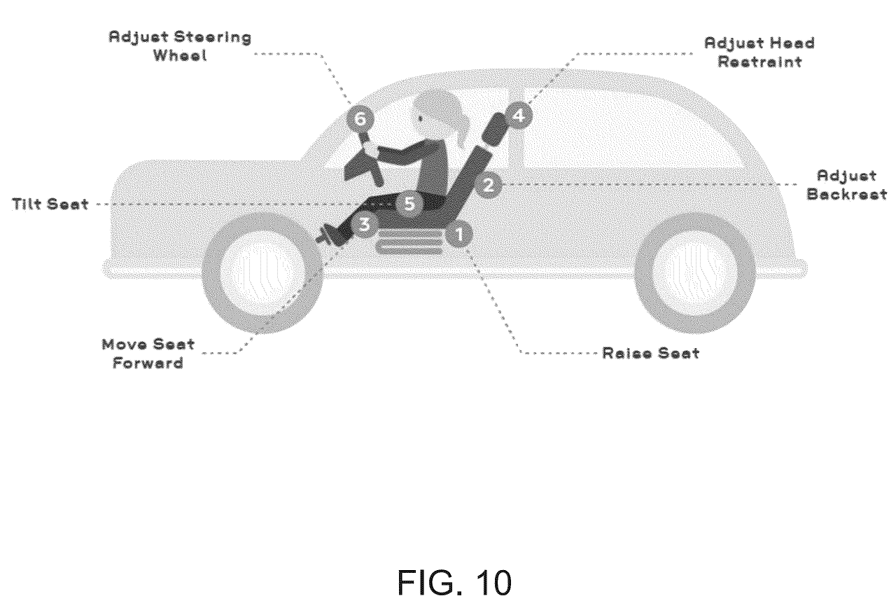

Thus, the system provides customized comfort for the user as the automated seat, mirrors (e.g., exterior rearview mirrors and/or an interior rearview mirror), pedals, displays, and/or steering wheel adjustment provides a personalized and comfortable seating experience (FIG. 10). The system also saves time for the driver or other passenger of the vehicle by eliminating the need for manual seat and/or mirror adjustment. The system also provides consistency by ensuring a consistent and optimal seating and mirror position for each driver. The system may provide improved driver safety by reducing distractions associated with manual seat and mirror adjustments. Additionally, the system enhances accessibility for drivers with physical limitations or disabilities. The inclusion of the feature may add value when selling the vehicle. The system creates a more driver-centric experience by automating seat and mirror adjustments and may incorporate advanced artificial intelligence and/or machine learning concepts for an elevated technological experience. The system may utilize aspects of the driver monitoring systems described in U.S. patent application Ser. No. 18/392,056, filed Dec. 21, 2023 (Attorney Docket MAG04 P5027), which is hereby incorporated herein by reference in its entirety.

Although the system has been described with respect to seat, mirror, display, and/or steering wheel adjustments for the driver of the vehicle, the system may identify any occupant of the vehicle and, if the occupant is seated in an automatically adjustable seat of the vehicle (i.e., a seat equipped with motors and/or actuators with which to adjust the seat's position), determine and/or adjust the optimal seating position for the occupant. Optionally, the system adjusts the seat of the driver along with one or more other components of the vehicle (e.g., mirrors, displays, pedals, steering wheel, etc.) based on a profile of the driver while only adjusting a seat for one or more other occupants of the vehicle based on profiles for the one or more other occupants.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,518,401; 10,958,830; 10,065,574; 10,017,114; 9,405,120 and/or 7,914, 187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/508,351, filed Nov. 14, 2023 (Attorney Docket DON01 P4996), and/or Ser. No. 18/535,183, filed Dec. 11, 2023 (Attorney Docket MAG04 P5021), and/or International Publication Nos. WO 2023/220222; WO 2022/241423; WO 2022/187805 and/or WO 2023/034956, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle and sensing the interior cabin of the vehicle.

The coaxial cable provides bi-directional communication between the mirror head and the ECU that is located at the vehicle remote from the mirror head. For example, the coaxial cable may provide power from the ECU to the mirror head and may provide control signals or data to the mirror head, and may receive image data from the camera at the mirror head. The coaxial cable and electronic connection between the ECU and the mirror head may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the DMS camera from the mirror head to the ECU, (ii) control signals from the ECU to the mirror head (such as for controlling the camera and/or a light emitter and/or dimming circuitry of the mirror head), and (iii) electrical power from a DC power supply of (or connected to) the ECU to the mirror head.

Optionally, the driver monitoring system may be integrated with a camera monitoring system (CMS) of the vehicle. The integrated vehicle system incorporates multiple inputs, such as from the inward viewing or driver monitoring camera and from the forward or outward viewing camera, as well as from a rearward viewing camera and sideward viewing cameras of the CMS, to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Publication Nos. US-2021-0245662; US-2021-0162926; US-2021-0155167; US-2018-0134217 and/or US-2014-0285666, and/or International Publication No. WO 2022/150826, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driver monitoring system, the vehicular driver monitoring system comprising:
a camera disposed at an interior cabin of a vehicle equipped with the vehicular driver monitoring system and viewing at least a portion of a driver of the vehicle, wherein the camera is operable to capture image data;
wherein the camera comprises a CMOS imaging array having at least one million photosensors arranged in rows and columns;
an electronic control unit (ECU) comprising electronic circuitry and associated software;
wherein image data captured by the camera is transferred to and is processed at the ECU;
wherein the vehicular driving monitoring system, via processing at the ECU of image data captured by the camera and transferred to the ECU, determines location of the head of the driver within the interior cabin of the vehicle;
wherein the vehicular driver monitoring system determines a configuration for a driver's seat of the vehicle based at least in part on the determined location of the head of the driver; and
wherein the vehicular driver monitoring system adjusts the driver's seat of the vehicle using the determined configuration for the driver's seat.

2. The vehicular driver monitoring system of claim 1, wherein the vehicular driver monitoring system determines the location of the head of the driver responsive to determining that the driver of the vehicle does not have a profile comprising the determined configuration for the driver's seat.

3. The vehicular driver monitoring system of claim 2, wherein the vehicular driver monitoring system determines that the driver of the vehicle does not have a profile comprising the determined configuration for the driver's seat based on facial recognition.

4. The vehicular driver monitoring system of claim 1, wherein the vehicular driver monitoring system generates a profile for the driver, and wherein the profile comprises the determined configuration for the driver's seat.

5. The vehicular driver monitoring system of claim 4, wherein the vehicular driver monitoring system, responsive to a manual adjustment of the driver's seat by the driver, updates the profile for the driver.

6. The vehicular driver monitoring system of claim 4, wherein the profile for the driver is stored at the vehicle.

7. The vehicular driver monitoring system of claim 4, wherein the profile for the driver is stored at a database remote from the vehicle and in wireless communication with the vehicle.

8. The vehicular driver monitoring system of claim 1, wherein the vehicular driver monitoring system determines weight of the driver, and wherein the vehicular driver monitoring system determines the configuration for the driver's seat based in part on the determined weight of the driver.

9. The vehicular driver monitoring system of claim 8, wherein the vehicular driver monitoring system determines the weight of the driver based on a pressure sensor disposed at the driver's seat.

10. The vehicular driver monitoring system of claim 1, wherein the vehicular driver monitoring system determines the configuration for the driver's seat based on a prediction from a machine learning model.

11. The vehicular driver monitoring system of claim 10, wherein the machine learning model is further trained on a manual adjustment of the driver's seat by the driver.

12. The vehicular driver monitoring system of claim 1, wherein the vehicular driver monitoring system determines a configuration for a mirror reflective element of a rearview mirror assembly of the vehicle based at least in part on the determined location of the head of the driver.

13. The vehicular driver monitoring system of claim 12, wherein the mirror reflective element is adjusted relative to the driver using the determined configuration for the mirror reflective element.

14. The vehicular driver monitoring system of claim 12, wherein the rearview mirror assembly comprises an interior rearview mirror assembly of the vehicle.

15. The vehicular driver monitoring system of claim 12, wherein the rearview mirror assembly comprises a side-mounted exterior rearview mirror assembly of the vehicle.

16. The vehicular driver monitoring system of claim 1, wherein the vehicular driver monitoring system determines the configuration for the driver's seat of the vehicle based in part on a request from the driver.

17. The vehicular driver monitoring system of claim 1, wherein the vehicular driver monitoring system determines a configuration for a display based at least in part on the determined location of the head of the driver and the determined configuration for the driver's seat.

18. A vehicular driver monitoring system, the vehicular driver monitoring system comprising:
a camera disposed at an interior cabin of a vehicle equipped with the vehicular driver monitoring system and viewing at least a portion of a driver of the vehicle, wherein the camera is operable to capture image data;
wherein the camera comprises a CMOS imaging array having at least one million photosensors arranged in rows and columns;
an electronic control unit (ECU) comprising electronic circuitry and associated software;
wherein image data captured by the camera is transferred to and is processed at the ECU;
wherein the vehicular driving monitoring system, via processing at the ECU of image data captured by the camera and transferred to the ECU, determines location of the head of the driver within the interior cabin of the vehicle;
wherein the vehicular driver monitoring system determines a configuration for a driver's seat of the vehicle based at least in part on the determined location of the head of the driver;
wherein the vehicular driver monitoring system adjusts the driver's seat of the vehicle using the determined configuration for the driver's seat;
wherein the vehicular driver monitoring system, responsive to a manual adjustment of the driver's seat by the driver, updates a profile for the driver; and
wherein the vehicular driver monitoring system determines a configuration for a mirror reflective element of a rearview mirror assembly of the vehicle based at least in part on the determined location of the head of the driver.

19. The vehicular driver monitoring system of claim 18, wherein the vehicular driver monitoring system determines the location of the head of the driver responsive to determining that the driver of the vehicle does not have a profile comprising the determined configuration for the driver's seat.

20. The vehicular driver monitoring system of claim 19, wherein the vehicular driver monitoring system determines that the driver of the vehicle does not have a profile comprising the determined configuration for the driver's seat based on facial recognition.

21. The vehicular driver monitoring system of claim 18, wherein the vehicular driver monitoring system generates a profile for the driver, and wherein the profile comprises the determined configuration for the driver's seat.

22. The vehicular driver monitoring system of claim 18, wherein the mirror reflective element is adjusted relative to the driver using the determined configuration for the mirror reflective element.

23. A vehicular driver monitoring system, the vehicular driver monitoring system comprising:
a camera disposed at an interior cabin of a vehicle equipped with the vehicular driver monitoring system and viewing at least a portion of a driver of the vehicle, wherein the camera is operable to capture image data;
wherein the camera comprises a CMOS imaging array having at least one million photosensors arranged in rows and columns;
a pressure sensor disposed at a driver's seat of the vehicle, wherein the pressure sensor is operable to capture weight data;
an electronic control unit (ECU) comprising electronic circuitry and associated software;
wherein image data captured by the camera and weight data captured by the pressure sensor is transferred to and is processed at the ECU;
wherein the vehicular driving monitoring system, via processing at the ECU of image data captured by the camera and transferred to the ECU, determines location of the head of the driver within the interior cabin of the vehicle;
wherein the vehicular driver monitoring system, via processing at the ECU of weight data captured by the pressure sensor and transferred to the ECU, determines weight of the driver;
wherein the vehicular driver monitoring system determines a configuration for the driver's seat of the vehicle based at least in part on (i) the determined location of the head of the driver and (ii) the determined weight of the driver; and
wherein the vehicular driver monitoring system adjusts the driver's seat of the vehicle using the determined configuration for the driver's seat.

24. The vehicular driver monitoring system of claim 23, wherein the vehicular driver monitoring system determines the configuration for the driver's seat based on a prediction from a machine learning model.

25. The vehicular driver monitoring system of claim 24, wherein the machine learning model is further trained on a manual adjustment of the driver's seat by the driver.

26. The vehicular driver monitoring system of claim 23, wherein the vehicular driver monitoring system determines the configuration for the driver's seat of the vehicle based in part on a request from the driver.
